(19) United States
(12) Patent Application Publication
(10) Pub. No.: US 2005/0275222 A1
(43) Pub. Date: Dec. 15, 2005

(54) Gasket for a fluid connection

(76) Inventor: John A. Yoakam, North Ridgeville, OH (US)

Correspondence Address: Cynthia S. Murphy;Renner, Otto, Boisselle & Sklar, LLP, Nineteenth Floor, 1621 Euclid Avenue, Cleveland, OH, 44115, US

(21) Appl. No.: 11/137,229

(22) Filed: May 25, 2005

Related U.S. Application Data
(60) Provisional application No. 60/579,384, filed on Jun. 14, 2004.

(51) Int. Cl. F16L 25/00

(52) U.S. Cl. 285/354

(57) ABSTRACT

A fluid connection (12) comprising a first coupling component (14), a second coupling component (16), and a sealing gasket (10). A first sealing bead (32) extends axially outward from the inner face (22) of the first coupling component (14), and a second sealing bead (34) extends axially outward from the inner face (28) of the second coupling component (16). The sealing gasket (10) comprises a first circular groove and a second circular groove which receive the first and second sealing beads (32, 34), respectively.

### RELATED APPLICATION

This application claims priority under 35 U.S.C. §119(e) to U.S. Provisional Patent Application No. 60/579,384 filed on Jun. 14, 2004. The entire disclosure of this provisional application is hereby incorporated by reference.

### FIELD OF THE INVENTION

This invention relates generally as indicated to a gasket and, more particularly, to a gasket for a fluid connection comprising a first coupling component, a second coupling component, and a coupling nut which draws the coupling components together.

### BACKGROUND OF THE INVENTION

A common fluid connection comprises a first coupling component, a second coupling component, and a coupling nut which draws the coupling components together. The inner faces of the first and second coupling components are disposed in an end-to-end relationship to provide a through-path between the respective passageways. A sealing bead extends axially outward from the inner face of the first coupling component and a similar sealing bead extends axially outward from the inner face of the second coupling component. A sealing gasket is interposed between the beads, and seals the union between the first and second coupling components. When the fluid connection is intended for use in semiconductor fabrication systems (wherein contamination is measured on a parts-per-billion basis) as the sealing gasket must be ultra-clean to satisfy the strict purity standards.

### SUMMARY OF THE INVENTION

The present invention provides an improved sealing gasket for interposition between the sealing beads of the coupling components. The sealing gasket does not require indentation or other particulate-generating contact between the gasket and the sealing beads. Moreover, any particulates generated will be captured within the groove below the sealing ring. Accordingly, the sealing gasket of the present invention can be used in ultra high purity gas delivery applications. Additionally or alternatively, the design of the present invention is believed to help the relevant coupling components “grab” the gasket and eliminate torquing or galling of the fitting.

More particularly, the present invention provides a fluid connection comprising a first coupling component, a second coupling component, and a sealing gasket. The sealing gasket is interposed between inner faces of the first and second coupling components, and comprises an annular body having a first side face, a second side face and an axially extending through-hole, and the sealing gasket. The gasket's first side face includes a circular groove and the gasket's second side face includes a circular groove, which receive respectively first and second sealing beads. At least two interference contact circles are created between the sealing bead and the groove in which it is received, these interference circles preferably being along the radially inner and outer edges of each the grooves. The sealing beads and the grooves can each have a semi-circular cross-sectional geometry, with the radius of the grooves being slightly less than the radius of the sealing beads. Alternatively, the sealing beads can have a parabolic cross-sectional shape and the grooves have a roughly trapezoidal shape.

These and other features of the invention are fully described and particularly pointed out in the claims. The following description and annexed drawings set forth in detail a certain illustrative embodiment of the invention, this embodiment being indicative of but one of the various ways in which the principles of the invention may be employed.

### DRAWINGS

FIG. 1 is an exploded side elevational view of a fluid connection according to the present invention.

FIG. 2 is a cross-sectional view of the assembled fluid connection.

FIG. 3 is an enlarged cross-sectional view of a sealing gasket of the fluid connection.

FIG. 4 is a plan view of the sealing gasket.

FIG. 5 is an enlarged cross-sectional view of the groove and a sealing bead of the fluid connection.

FIG. 6 is a view similar to FIG. 5, with the groove having a modified geometry.

FIG. 7 is a view similar to FIG. 5, with both the sealing ring and the groove having a modified geometry.

### DETAILED DESCRIPTION

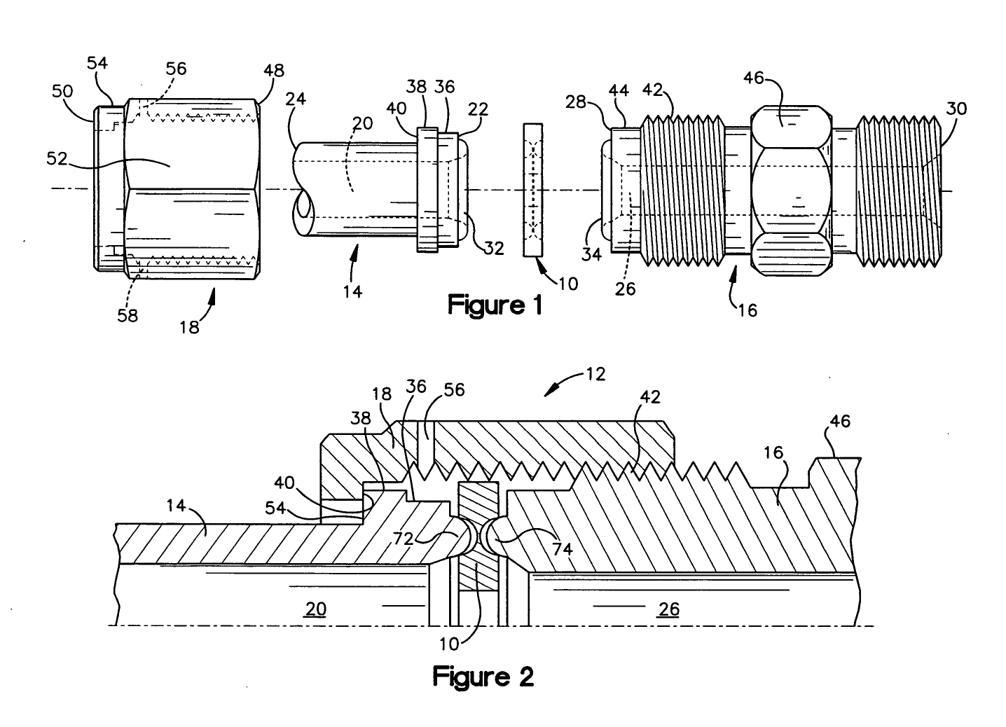

Referring now to FIGS. 1 and 2, a sealing gasket 10 according to the present invention is shown incorporated into a fluid connection 12. In addition to the gasket 10, the illustrated fluid connection 12 comprises a first coupling component 14, a second coupling component 16, and a coupling nut 18.

The first coupling component 14 comprises a fluid passageway 20 extending longitudinally between its inner face 22 and its outer end 24. The second coupling component 16 comprises a fluid passageway 26 extending longitudinally between its inner face 28 and its outer end 30. In the assembled fluid connection 12, the inner faces 22 and 28 are disposed in an end-to-end relationship to provide a through-path between the passageways 20 and 26. The outer ends 24 and 30 are adapted for connection to first and second fluid lines or another associated structure.

A sealing bead 32 extends axially outward from the inner face 22 of the first coupling component 14, and a similar sealing bead 34 extends axially outward from the inner face 28 of the second coupling component 16. The sealing beads 32 and 34 are each coaxial with the passageway 20 and the passageway 26, respectively. On the first coupling component 14, a stepped radial flange, next to the inner face 22, forms a first circumferential ledge 36; a second, greater diameter, circumferential ledge 38; and an annular axial face 40. On the second coupling component 16, a threaded area 42 is positioned next to the inner face 28, a ledge 44 extends between the face 28 and the area 42, and a hexagonal-tool-receiving area 46 is positioned adjacent to the threaded area 42.

The coupling nut 18 comprises an open-ended structure having a forward end 48, a rear end 50, and an interior bore 52 extending therebetween. With the exception of a rearward portion, the bore 52 has a diameter greater than that of the ledge 38 of the first coupling component 14 and is adapted for threaded engagement with the threaded area 42 of the second coupling component 16. The rearward portion of the bore 52 has a smaller diameter, less than that of the ledge 38 of the first coupling component 14, thereby forming a shoulder 54. Test ports 56 can be provided as necessary or desired.

To assemble the fluid connection 12, the coupling components 14 and 16 are placed in an end-to-end relationship so that the sealing beads 32 and 34 are disposed in opposed relationship to each other. The sealing gasket 10 is interposed between the beads 32 and 34, and the first and second coupling components 14 and 16 are drawn together by the nut 18. Specifically, the nut 18 is slipped over the stepped flange (36, 38, 40) of the first coupling component 14 so that its interior threads engage the threaded area 42 of the second coupling component 16. One wrench may then be used to grasp the hexagonal-tool-receiving area 46 on the second coupling component 16 to stabilize it while another wrench is used to turn the nut 18. The abutting of the nut's shoulder 54 with the circumference ledge 38 of the first coupling component 14 will indicate proper engagement between the coupling components 14 and 16.

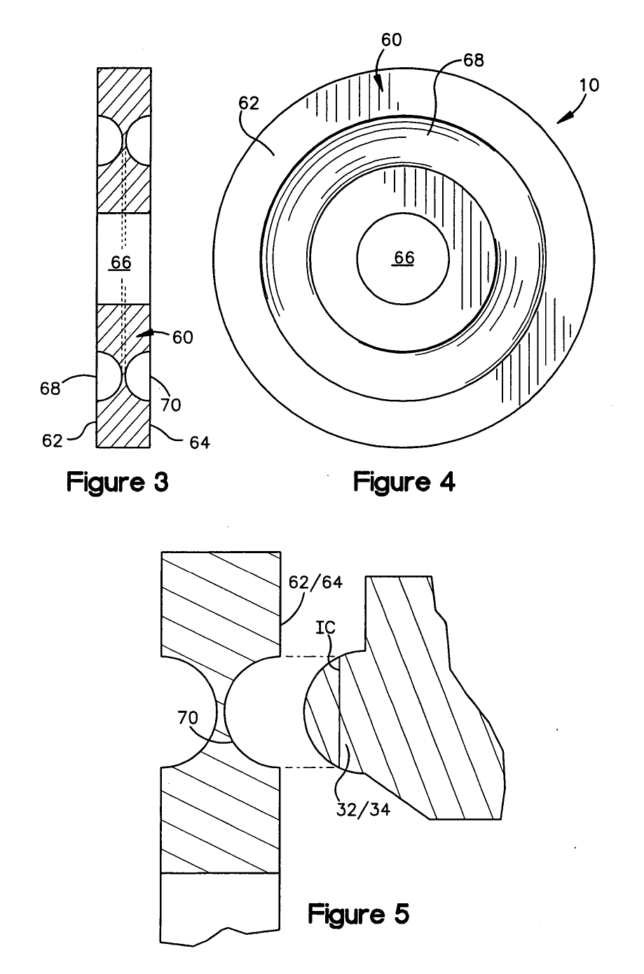

Referring now to FIGS. 3 and 4, the sealing gasket 10 is shown isolated from the rest of the fluid connection 12. The sealing gasket 10 comprises an annular body 60 having a first side face 62, a second side face 64, and an axially extending through-hole 66. The first side face 62 includes a circular groove 68 and the second side face 64 includes a circular groove 70. The sealing gasket 10 can be made of a sealing material and, more particularly, a sealing metal such as nickel, steel, or copper (e.g., Nickel 201, 316L Stainless Steel, 316L Silver Plated Stainless Steel, and copper), a “soft metal” (e.g., titanium) and/or suitable plastic seal materials.

Referring back to FIG. 2, and additionally to FIG. 5, in the fluid connection 12, the sealing gasket 10 is positioned between the inner faces 22 and 28 of the first and second coupling components 14 and 16. The grooves 68 and 70 are radially positioned to receive the sealing beads 32 and 34, respectively, in the fluid connection 12. The cross-sectional geometry of the gasket's grooves 68/70 is selected to correspond to the cross-sectional geometry of the sealing beads 32/34 so that an interference chord IC is created between the beads 32/34 and the grooves 68/70 thereby locking the gasket 10 in place and preventing torquing and/or galling of the fitting.

In the sealing gasket arrangement illustrated in FIGS. 3-5, the sealing beads 32/34 each have a semi-circular cross-sectional geometry with a radius R_{bead}, and the grooves 68/70 each have a semi-circular cross-sectional geometry with a radius R_{groove}. The radius R_{groove} of the groove 68/70 is slightly less than the radius R_{bead} of the bead 32/34. For example, if the radius R_{bead} of the bead 32/34 is 0.032 inches, the radius R_{groove} of the groove 68/70 could be 0.029 inches. In this manner, as the sealing bead 32/34 is received in the groove 68/70, the bead's proximate radially inner and outer portions will contact the radially inner and outer edges of the groove 68/70 to create interference contact chord IC therebetween.

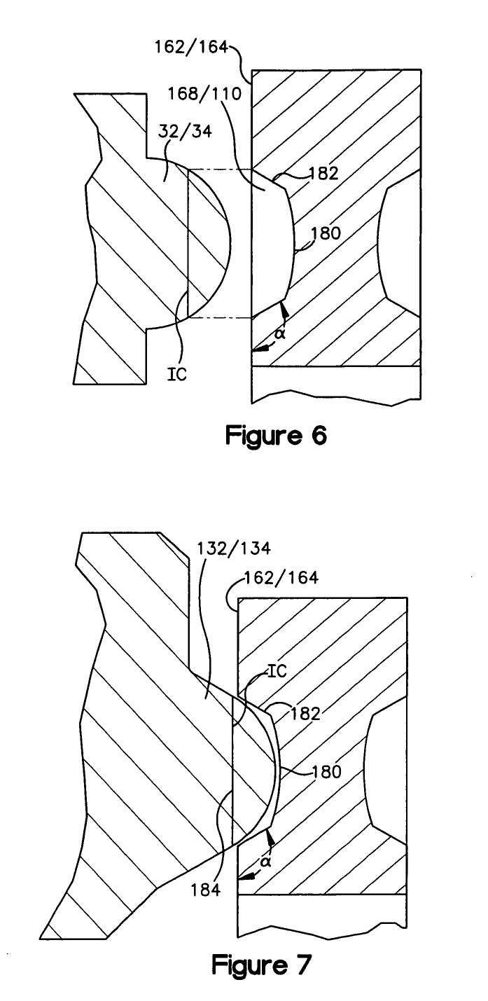

In the alternative sealing gasket arrangement illustrated in FIG. 6, the grooves 168/170 have a roughly trapezoidal shape, with a curved bottom wall 180 and side walls 182 extending from the face 162/164 to the bottom wall 180 at an obtuse angle a (e.g., 120° relative to the face 162/164, or 30° relative to a line perpendicular to the face 162/164). The depth of the bottom wall 180, and the angle a of the side walls 182, are dimensioned so that radially inner and outer sides of the bead 32/34 will contact inner and outer edges of the groove 168/170 upon the bead's nose contacting the bottom wall 180, at a level referenced by chord 184.

In the alternative sealing gasket arrangement shown in FIG. 7, the sealing rings 132/134 have a parabolic shape. The depth of the bottom wall 180, and the angle α of the side walls 182, are dimensioned so that radially inner and outer sides of the bead 32/34 will contact inner and outer edges of the groove 168/170 prior to the bead's nose contacting the bottom wall 180. Upon contact of the nose with the bottom wall 180 at a level reference by chord 184, the angular force will move the sealing bead 132/134 back to the original contacts circles aligned with chord IC.

Accordingly, the sealing gasket 10/110 do not require any indentation or other particulate-generating contact with the sealing rings 132/134. Moreover, any particulates generated will be captured within the groove below the sealing ring. As such, the sealing gaskets 10 are suitable for use in ultra high purity gas delivery applications, such as used in semiconductor fabrication systems wherein contamination is controlled on a parts-per-billion scale.

Although the invention has been shown and described with respect to certain preferred embodiments, it is apparent that equivalent and obvious alterations and modifications will occur to others skilled in the art upon the reading and understanding of this specification. The present invention includes all such alterations and modifications and is limited only by the scope of the following claims.

1. A fluid connection comprising a first coupling component, a second coupling component, and a sealing gasket;
wherein the first coupling component comprises a fluid passageway extending longitudinally between its inner face and its outer end, the second coupling component comprises a fluid passageway extending longitudinally between its inner face and its outer end, and the inner faces are disposed in an end-to-end relationship to provide a through-path between the passageways;
wherein a first sealing bead extends axially outward from the inner face of the first coupling component, and a second sealing bead extends axially outward from the inner face of the second coupling component;
wherein the sealing gasket comprises an annular body having a first side face, a second side face and an axially extending through-hole, and the sealing gasket is interposed between inner faces of the first and second coupling components;
wherein the first side face includes a circular groove and the second side face includes a circular groove, which receive the first and second sealing beads, respectively; and
wherein an interference contact chord is created between each of the first and second sealing beads and the groove in which it is received.

2. A fluid connection as set forth in claim 1, wherein the sealing beads each have a semi-circular cross-sectional geometry, wherein the grooves each have a semi-circular cross-sectional geometry, and where the radius of the grooves is slightly less than the radius of the sealing beads.

3. A fluid connection as set forth in claim 1, wherein the sealing beads have a semi-circular cross-sectional shape and the grooves have a roughly trapezoidal shape.

4. A fluid connection as set forth in claim 3, wherein the grooves each have a bottom wall and side walls extending from the respective face of the sealing gasket to the bottom wall at an obtuse angle.

5. A fluid connection as set forth in claim 4, wherein the bottom wall is curved.

6. A fluid connection as set forth in claim 4, wherein the depth of the bottom wall, and the angle of the side walls, are dimensioned so that radially inner and outer sides of the sealing bead will contact inner and outer edges of the groove upon the nose of the sealing bead contacting the bottom wall.

7. A fluid connection as set forth in claim 1, wherein the sealing beads have a parabolic cross-sectional shape and the grooves have a roughly trapezoidal shape.

8. A fluid connection as set forth in claim 7, wherein the grooves each have a bottom wall and side walls extending from the respective face of the sealing gasket to the bottom wall at an obtuse angle.

9. A fluid connection as set forth in claim 8, wherein the bottom wall is curved.

10. A fluid connection as set forth in claim 8, wherein the depth of the bottom wall, and the angle of the side walls, are dimensioned so that radially inner and outer sides of the sealing bead will contact inner and outer edges of the groove prior to the nose of the sealing bead contacting the bottom wall.

11. A fluid connection as set forth in claim 1, further comprising a nut used to draw together the first and second coupling components during assembly of the fluid connection.

12. A fluid connection as set forth in claim 1, wherein the sealing gasket is made of a metal.

13. A fluid connection as set forth in claim 10, wherein the sealing gasket is made of nickel.

14. A fluid connection as set forth in claim 10, wherein the sealing gasket is made of steel.

15. A fluid connection as set forth in claim 10, wherein the sealing gasket is made of copper.

16. A fluid connection as set forth in claim 10, wherein the sealing gasket is made of titanium.

17. A fluid connection as set forth in claim 10, wherein the sealing gasket is made of plastic.
